(19) United States
(12) Patent Application Publication
(10) Pub. No.: US 2006/0212230 A1
(43) Pub. Date: Sep. 21, 2006

(54) Method and apparatus for extracting relation between genes, and computer product

(75) Inventors: Hiroshi Yamakawa, Kawasaki (JP); Kouji Maruhashi, Kawasaki (JP); Yoshio Nakao, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/192,095

(22) Filed: Jul. 29, 2005

(30) Foreign Application Priority Data
Mar. 16, 2005 (JP) 2005-075726

(51) Int. Cl. G06F 19/00

(52) U.S. Cl. 702/20

(57) ABSTRACT

An apparatus for extracting a relation between a plurality of genes based on expression data regarding to an expression amount of the genes, includes: a generating unit that generates contexts based on expression data of a plurality of genes satisfying a predetermined relation, the contexts representing an environment for an expression of a gene; and a determining unit that determines a relation between the genes in the contexts generated.

### BACKGROUND OF THE INVENTION

1. Field of the Invention

The present invention relates to a technology for extracting relations between a plurality of genes elicited in specific contexts by generating various contexts based on expression data on an expression amounts of the genes.

2. Description of the Related Art

Recently, along with the advancement in gene analysis technology, expression states of genes as many as several thousands to tens of thousands can be grasped at once. Accordingly, a technique for extracting intergenic expression relations using the expression states of many genes is under development (for example, see domestic re-publication of PCT international publication for Patent Applications No. WO2002/048915, and Homin K. Lee, Amy K. Hsu, Jon Sajdak, Jie Qin and Paul Pavlidis, “Coexpression Analysis of Human Genes Across Many Microarray Data Sets,” Genome Research 14: 1085-1094, 2004)

Examples of the extracted intergenic expression relations include an expression relation about promotion and suppression between genes in which if an expression amount of a certain gene A becomes larger, that of another gene B becomes larger, or if the expression amount of the gene A becomes larger, that of another gene B becomes smaller. Specifying such an expression relation will help to uncover causes of a disease and to treat the disease.

However, it appears that the intergenic expression relation is elicited in a specific context (a gene expression environment). Therefore, if plural pieces of expression data acquired in varied contexts are analyzed at random, it is difficult to extract expression relations. Examples of the contexts include a spatial context such as a context of tissues or a context of intercellular sites, and a temporal context such as a context of growth periods and a context of cell cycles. The context as the gene expression environment is considered to be complicated since many factors influence one another.

### SUMMARY OF THE INVENTION

An apparatus according to an aspect of the present invention, which is an apparatus for extracting a relation between a plurality of genes based on expression data regarding to an expression amount of the genes, includes: a generating unit that generates contexts based on expression data of a plurality of genes satisfying a predetermined relation, the contexts representing an environment for an expression of a gene; and a determining unit that determines a relation between the genes in the contexts generated.

A method according to another aspect of the present invention, which is a method for extracting a relation between a plurality of genes based on expression data regarding to an expression amount of the genes, includes: generating contexts based on expression data of a plurality of genes satisfying a predetermined relation, the contexts representing an environment for an expression of a gene; and determining a relation between the genes in the contexts generated.

A computer-readable recording medium according to still another aspect of the present invention stores a computer program that causes a computer to execute the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A and 1B are schematics illustrating a concept of genetic relation extraction performed by a genetic relation extracting apparatus according to an embodiment of the present invention;

FIG. 2 is a block diagram of the genetic relation extracting apparatus;

FIG. 3 is a schematic illustrating an expression amount matrix input by a network extracting unit;

FIG. 4 is a schematic illustrating a correlation network from which partial networks are extracted by the network extracting unit;

FIG. 5 is a schematic illustrating a processing performed by a context generator;

FIG. 6 is a schematic illustrating a processing performed by a network comparator;

FIG. 7 is a schematic illustrating a processing performed by the network extracting unit;

FIG. 8 is a schematic illustrating a processing performed by the context generator;

FIG. 9 is a schematic illustrating a context generation processing performed by the context generator; and

FIG. 10 is a block diagram of a computer that executes a genetic relation extracting program according to the embodiment.

### DETAILED DESCRIPTION OF THE PREFERRED EMBODIMENTS

Exemplary embodiments of the present invention will be explained in detail with reference to the accompanying drawings.

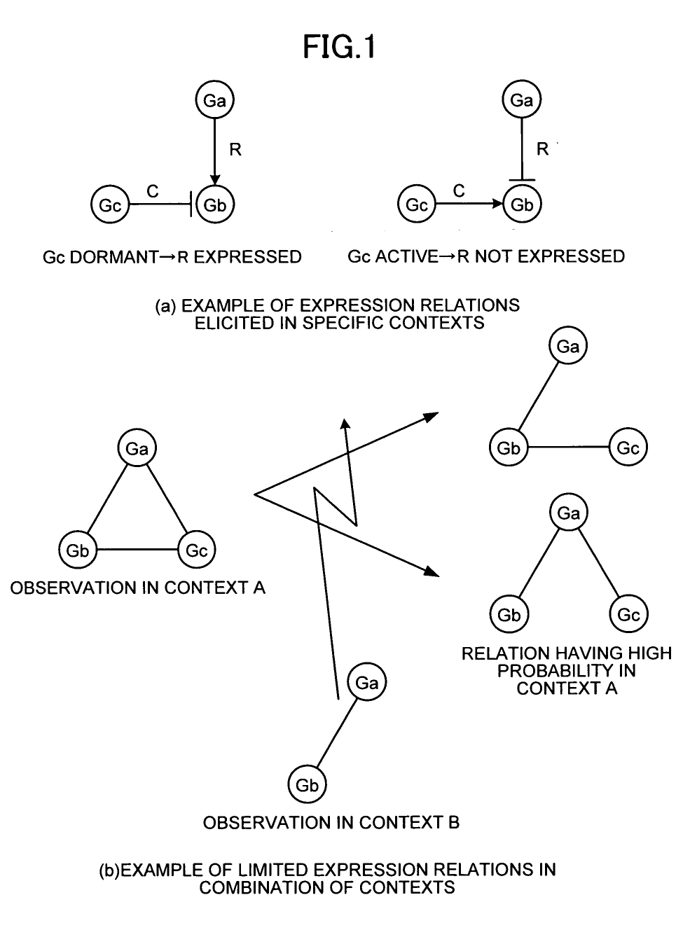

A concept of expression relation extraction performed by the genetic relation extracting apparatus according to this embodiment using contexts will be explained first. FIGS. 1A and 1B are explanatory views of the concept of expression relation extraction performed by the genetic relation extracting apparatus according to this embodiment using contexts.

An example of expression relations elicited in specific contexts is shown in FIG. 1A. In a context in which a gene Gc is dormant, a positive correlation, i.e., a relation that an expression amount of a gene Gb is larger if that of a gene Ga is larger occurs between the genes Ga and Gb. In a context in which the gene Gc is active, a negative correlation, i.e., a relation that the expression amount of the gene Gb is smaller if that of the gene Ga is larger occurs between the genes Ga and Gb.

An example of limited expression relations in a combination of contexts is shown in FIG. 1B. If a positive correlation is observed among the genes Ga, Gb, and Gc in a context A, and a positive correlation is observed between the genes Ga and Gb in a context B, then a probability that an expression relation in the context A includes the genes Ga and Gb is higher.

As can be seen, the genetic relation extracting apparatus according to this embodiment extracts expression relations among genes that are elicited in specific contexts using the contexts. In order to extract the expression relations using the contexts, the way of selecting the contexts is important.

The genetic relation extracting apparatus according to this embodiment selects contexts if many genes are synchronously expressed, that is, selects contexts based on synchronous expression of partial gene groups.

Alternatively, the apparatus can select contexts based on synchronous suppression of the partial gene groups instead of the synchronous expression thereof.

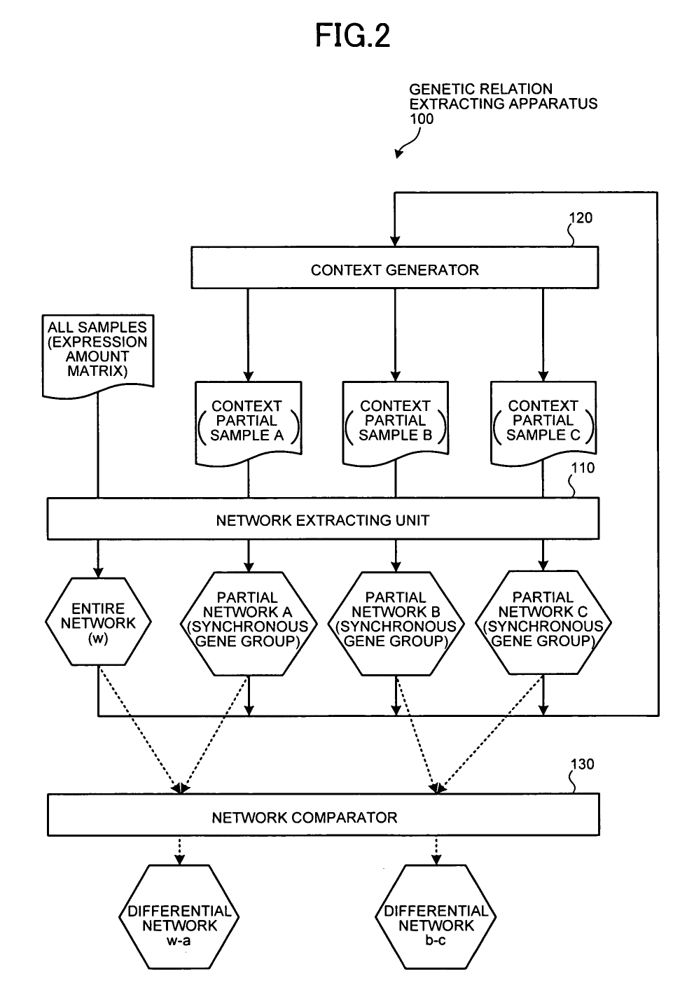

A configuration of the genetic relation extracting apparatus according to this embodiment will be explained. FIG. 2 is a block diagram of the genetic relation extracting apparatus according to this embodiment. As shown in FIG. 2, the genetic relation extracting apparatus 100 includes a network extracting unit 110, a context generator 120, and a network comparator 130.

The network extracting unit 110 inputs an expression amount matrix configured by a plurality of samples (plural pieces of expression data), creates a correlation network based on correlations among expression amounts of genes, and extracts partial networks from the created correlation network.

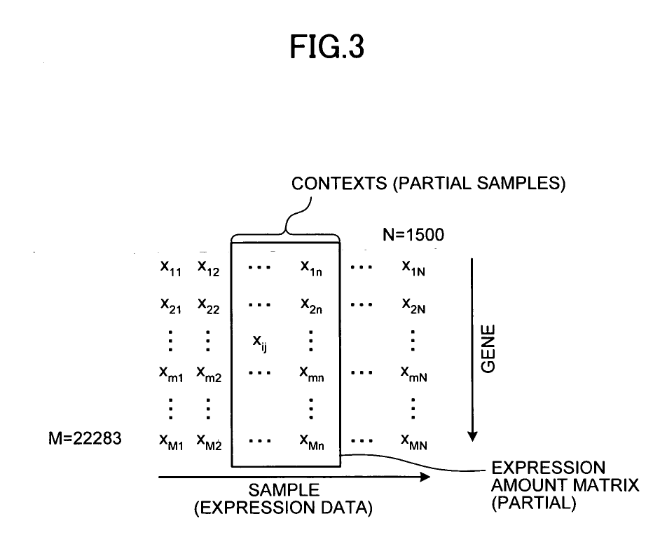

FIG. 3 is a schematic illustrating the expression amount matrix input by the network extracting unit 110. As shown in FIG. 3, the expression amount matrix is a matrix in which an expression amount of a gene m (1≦m≦M) in a sample n (1≦n≦N) is xₘₙ. In the instance shown in FIG. 3, M=22283 and N=1500.

A context is configured by a plurality of samples and corresponds to a partial matrix configured by a plurality of rows in the expression amount matrix. In FIG. 3, the context is configured by samples in continuous rows. However, row numbers of the rows that constitute the context are not necessarily continuous.

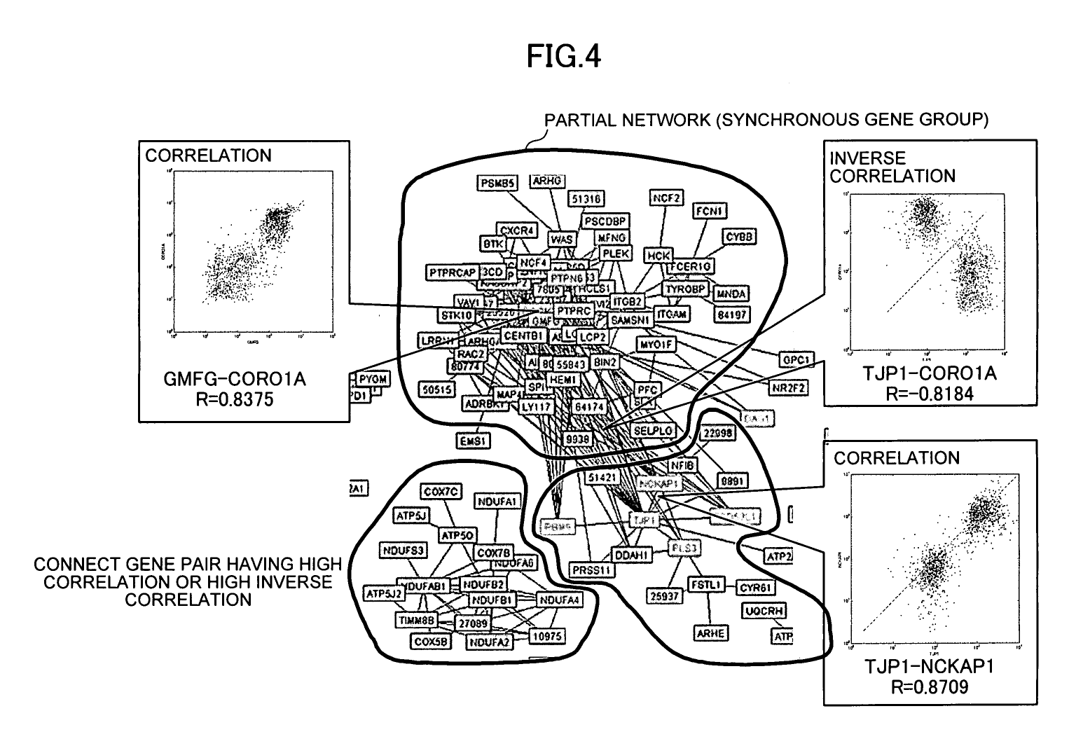

FIG. 4 is a schematic illustrating the correlation network from which the network extracting unit 110 extracts partial networks. In FIG. 4, “GMFG”, “CORO1A”, “TJP1”, “NCKAP1”, and the like denote gene names, respectively, and a line between two genes indicates that an absolute value of a correlation coefficient between the expression amounts of the two genes is equal to or greater than a predetermined value.

In the correlation network, if the correlation coefficient between the expression amounts of the two genes is higher, that is, the correlation between the two genes is higher, the two genes are arranged closer to each other.

A correlation coefficient between, for example, the genes “TJP1” and “NCKAP1” is 0.8709 and the genes “TJP1” and “NCKAP1” are arranged close to each other. If the expression amount of a sample j about a gene i is xij, a correlation coefficient rαβ of a gene pair (α, β) is represented by

$${r}_{α β} = \frac{\frac{1}{n} {\sum }_{j = 1}^{n} ( {x}_{α j} - {\overline{x}}_{α} ) ( {x}_{β j} - {\overline{x}}_{β} )}{\sqrt{\frac{1}{n} {\sum }_{j = 1}^{n} {( {x}_{α j} - {\overline{x}}_{α} )}^{2} \sqrt{\frac{1}{n}} {\sum }_{j = 1}^{n} {( {x}_{β j} - {\overline{x}}_{β} )}^{2}}}$$

$$where$$

$${\overline{x}}_{α} = {\sum }_{j = 1}^{n} {x}_{α j} , \\ and$$

$${\overline{x}}_{β} = {\sum }_{j = 1}^{n} {x}_{β j} .$$

The network extracting unit 110 extracts synchronous gene groups that are groups of genes for which correlation coefficients are equal to or higher than a predetermined value (0.8, for example), from whole genes. If the correlation coefficient between the expression amounts of the two genes is equal to or higher than the predetermined value and the correlation network that connects the two genes by a line is created, the synchronous gene groups correspond to partial networks of the correlation network, respectively. The network extracting unit 110, therefore, extracts a plurality of partial networks from the correlation network.

In this embodiment, it is assumed that groups of genes in which each correlation coefficient between the expression amounts of the two genes is equal to or higher than the predetermined value, that is, groups of genes in which there is a high positive correlation between each gene pair are synchronous gene groups. Alternatively, groups of genes in which there is a high negative correlation between each gene pair can be assumed as the synchronous gene groups.

In this embodiment, the network extracting unit 110 calculates a correlation coefficient per gene pair, and creates the correlation network that links pairs each having the correlation coefficient equal to or higher than the threshold, thereby extracting the synchronous gene groups. Alternatively, the network extracting unit 110 can extract the synchronous gene groups by clustering the genes according to the correlation coefficients.

The context generator 120 calculates a typical expression amount for genes included in each of the partial networks extracted by the network extracting unit 110, i.e., for the genes belonging to each of the synchronous gene groups, and generates contexts based on the calculated typical expression amounts, respectively. The contexts correspond to partial samples that are subgroups obtained by dividing a group of all samples into a plurality of segments.

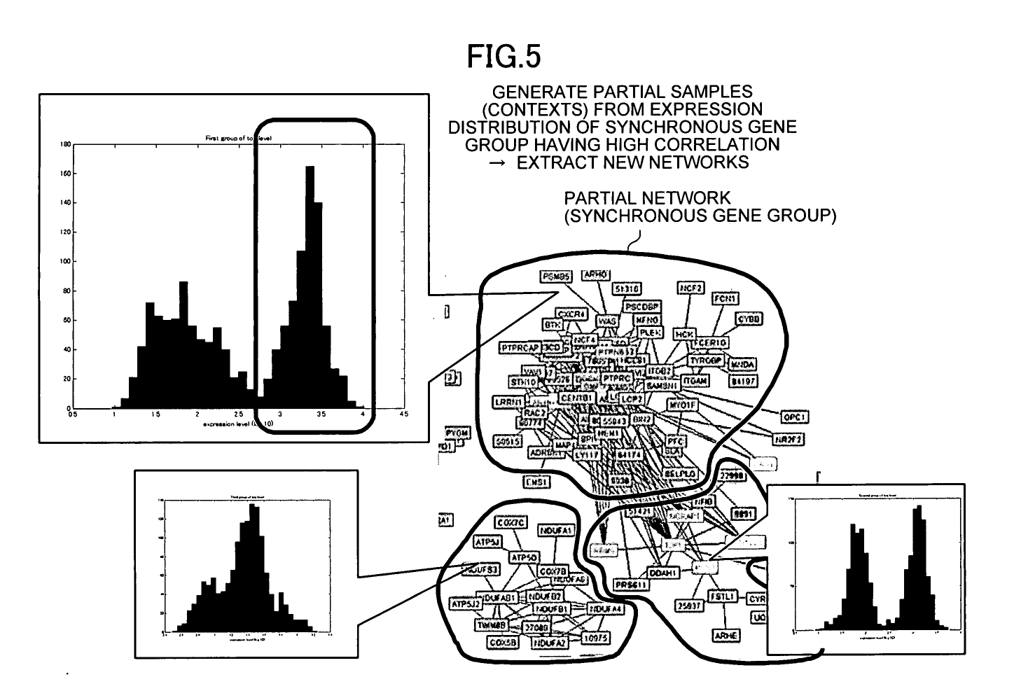

FIG. 5 is a schematic illustrating a context generation processing performed by the context generator 120. FIG. 5 depicts a histogram created by calculating average expression amounts of the genes belonging to each synchronous gene group as the typical expression amounts relative to the respective samples by the context generator 120, thereby creating the histogram for all samples according to the calculated averages. The context generator 120 divides the samples into a plurality of segments based on this histogram, thereby generating contexts.

For example, in FIG. 5, the histogram created based on the average expression amounts of the genes belonging to each synchronous gene group “a” can be divided into two hills. The context generator 120, therefore, generates contexts corresponding to the respective two hills.

As can be seen, the context generator 120 generates the contexts by dividing the samples based on the average expression amounts of the genes belonging to each synchronous gene group. Thus, the context generator 120 can extract each expression relation between the two genes in each specific context.

The network extracting unit 110 extracts synchronous gene groups for the partial sample corresponding to each context generated by the context generator 120. The context generator 120 generates contexts based on the average expression amounts of the genes belonging to each synchronous gene group extracted by the network extracting unit 110. By repeating this process, it is possible to generate various contexts and extract expression relations each between the two genes in the various contexts.

The repetition of the extraction of synchronous gene groups and the generation of contexts can be finished when a predetermined condition is satisfied, for example, when the number of samples belonging to each of the generated contexts is equal to or smaller than a predetermined value. Alternatively, the repetition can be finished by an instruction from a user.

In this embodiment, the context generator 120 uses the average expression amounts of the genes as the typical expression amounts of the genes belonging to each synchronous gene group. Alternatively, the context generator 120 can use, as the typical expression amount, another value such as a first main component obtained by singular value decomposition.

In this embodiment, the context generator 120 creates the histogram according to the average expression amounts and divides the samples based on the created histogram. Alternatively, the context generator 120 can obtain two or three or more contexts by applying clustering, binarization, or the like to the typical expression amounts.

The network comparator 130 compares and displays the various partial networks extracted by the network extracting unit 110. The network comparator 130 compares the various contexts by comparing correlation networks in the respective various contexts.

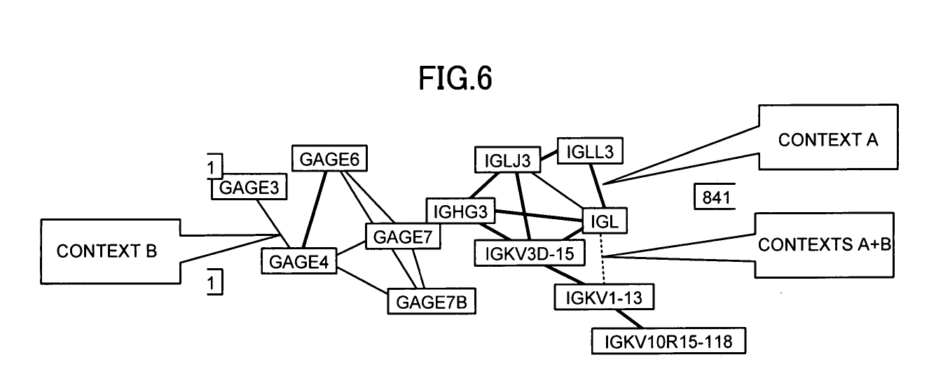

FIG. 6 is a schematic illustrating a context comparison processing performed by the network comparator 130. As shown in FIG. 6, the network comparator 130 compares and displays correlation networks in, for example, a context A, a context B, and contexts A+B.

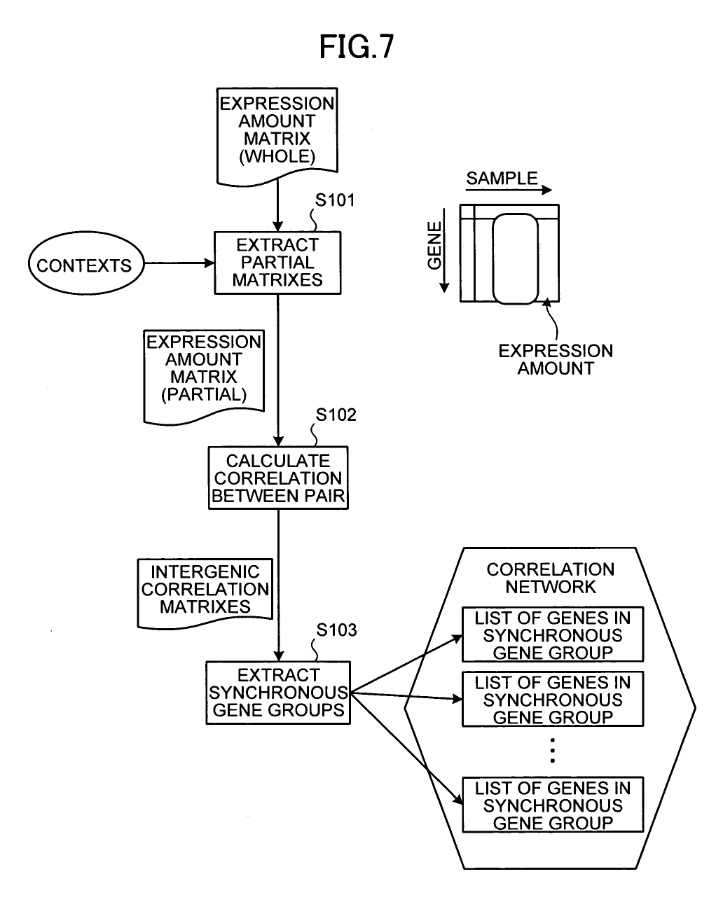

FIG. 7 is a schematic illustrating a processing performed by the network extracting unit 110. As shown in FIG. 7, the network extracting unit 110 extracts partial matrixes corresponding to specific contexts from a whole expression amount matrix (step S101). If the partial networks are extracted from all samples, the whole expression amount matrix is the partial matrix.

The network extracting unit 110 performs a pair correlation calculation of calculating the correlation coefficient between the expression amounts of two genes using each of the extracted partial matrixes (step S102), thus creating intergenic correlation matrixes. Each of the intergenic correlation matrixes is a matrix having a correlation coefficient r((between a gene pair ((, ( ) as elements.

Based on the created intergenic correlation matrixes, the network extracting unit 110 extracts synchronous gene groups from the whole gene groups (step S103). Namely, the network extracting unit 110 creates a correlation network based on the intergenic correlation matrixes, and extracts partial networks from the created correlation network.

Thus, by creating the correlation network for specific contexts, the network extracting unit 110 can extract expression relations elicited in the specific contexts. In addition, by extracting the partial networks from the created correlation network, the network extracting unit 110 can extract the synchronous gene groups used to generate new contexts.

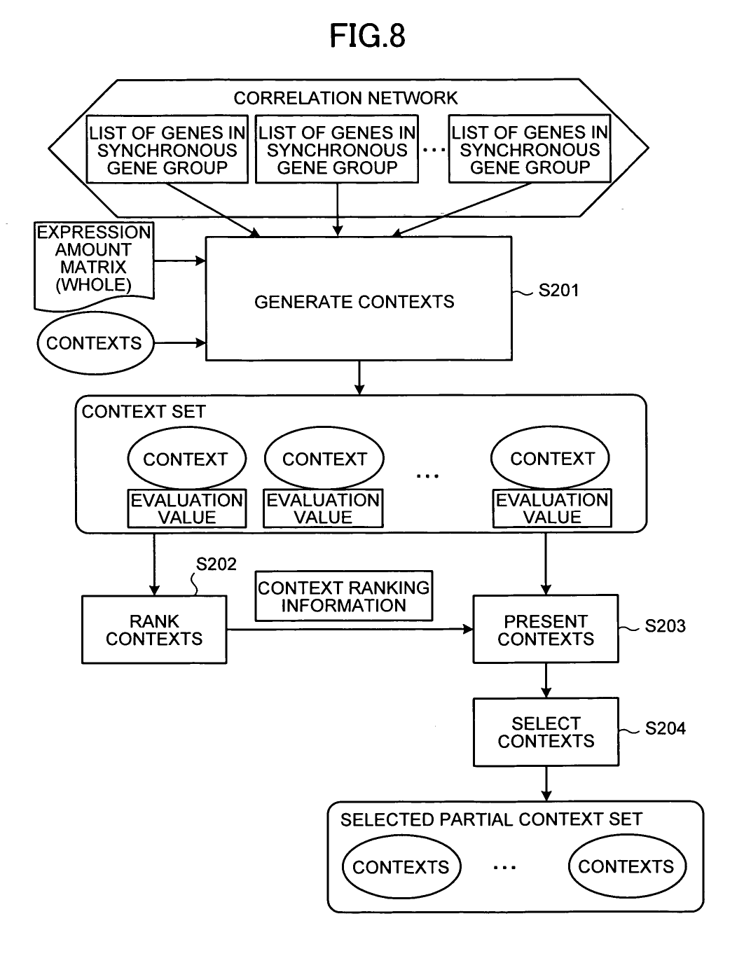

FIG. 8 is a schematic illustrating a processing performed by the context generator 120. As shown in FIG. 8, the context generator 120 generates new contexts using the whole expression amount matrix, the original contexts for generating the contexts, and the specific synchronous gene groups (step S201).

In addition to generation of contexts, the context generator 120 calculates an evaluation value for each of the generated contexts. As the evaluation value, the number of samples included in the context, a separation rate of the context from the other contexts, a variation amount thereof from the original contexts, or the like can be used.

The context generator 120 ranks the generated contexts based on their evaluation values (step S202), and presents the user with the ranks of the contexts and their evaluation values (step S203). The context generator 120 makes the user select contexts (step S204), and feeds the contexts selected by the user to the network extracting unit 110 as new contexts.

By generating the new contexts using the whole expression amount matrix, the original contexts for generating contexts, and the specific synchronous gene groups, the context generator 120 can extract the expression relations elicited in the specific contexts.

In this embodiment, the context generator 120 presents the user with the generated contexts and their evaluation values so that the user selects contexts. Alternatively, the context generator 120 can automatically select contexts having evaluation values equal to or higher than a predetermined value and feed the selected contexts to the network extracting unit 110.

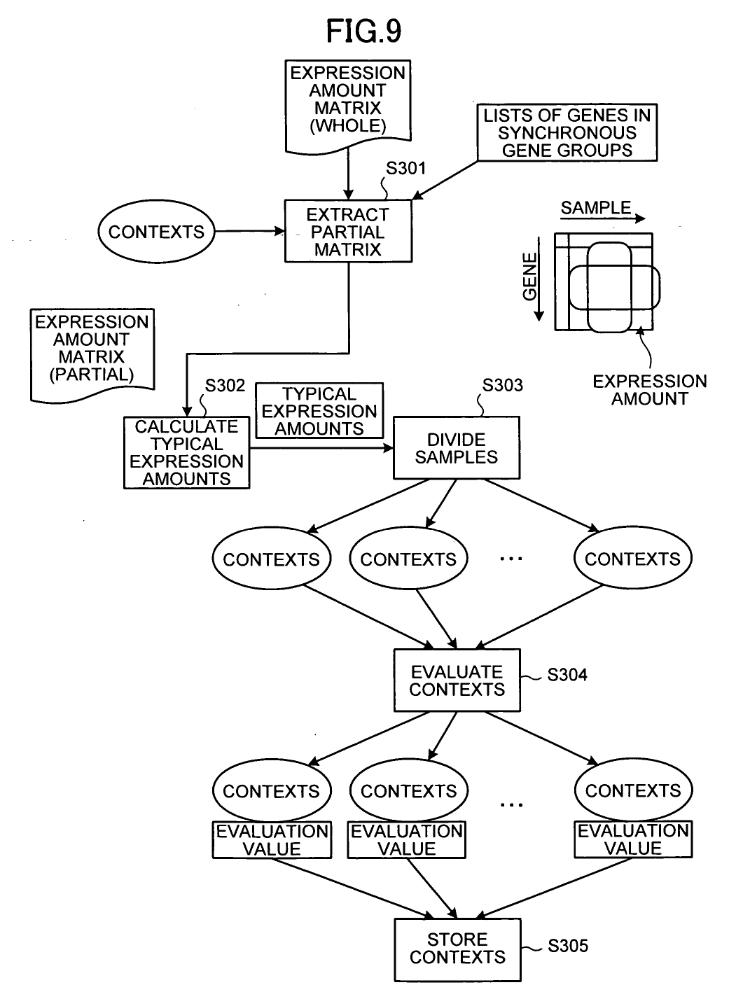

FIG. 9 is a schematic illustrating a context generation processing performed by the context generator 120. This context generation processing corresponds to the processing at the step S201 shown in FIG. 8.

As shown in FIG. 9, in this context generation processing, the context generator 120 extracts partial matrixes configured by the samples included in the original contexts and the expression amounts of the genes included in the synchronous gene groups, from the whole expression amount matrix (step S301). The context generator 120 also calculates typical expression amounts for the respective samples in the extracted partial matrixes, i.e., average expression amounts (step S302).

The context generator 120 creates a histogram based on the averages calculated for the respective samples, divides the samples from the created histogram, and generates contexts (step S303). The context generator 120 also calculates evaluation values for the respective generated contexts (step S304), and stores the evaluation values together with the respective contexts (step S305).

Thus, the context generator 120 calculates the average expression amounts of the genes included in the synchronous gene groups for the respective samples, divides the samples based on the calculated averages, and generates the contexts.

As explained, according to this embodiment, the network extracting unit 110 creates the correlation network from the expression amount matrix and extracts the synchronous gene groups. The context generator 120 generates contexts based on the expression amounts of the genes belonging to each of the specific synchronous gene groups. The network extracting unit 110 creates the correlation network from the expression amount matrix corresponding to the contexts generated by the context generator 120, thereby extracting the expression relations elicited in the specific contexts.

According to this embodiment, the generation of the contexts by the context generator 120 and the extraction of the synchronous gene groups by the network extracting unit 110 are repeatedly performed, thereby generating various contexts and extracting the expression relations elicited in the various contexts.

In this embodiment, the genetic relation extracting apparatus has been explained. By realizing the configuration of the genetic relation extracting apparatus by software, a genetic relation extracting program having functions similar to the genetic relation extracting apparatus can be obtained. A computer that executes this genetic relation extracting program will be explained next.

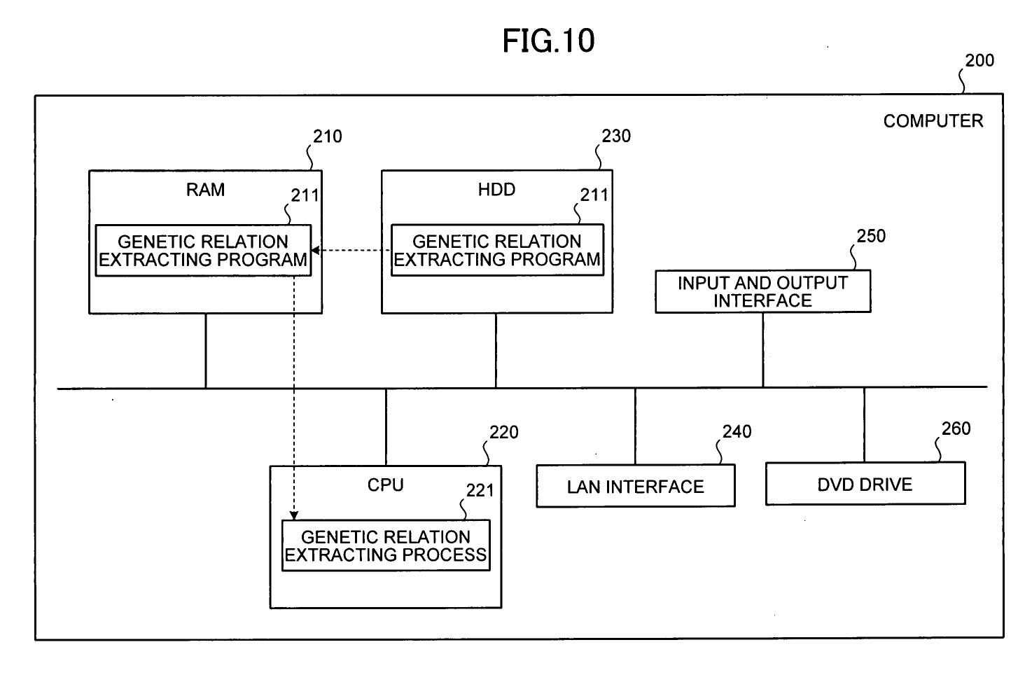

FIG. 10 is a block diagram of the computer that executes the genetic relation extracting program according to this embodiment. As shown in FIG. 10, a computer 200 includes a random access memory (RAM) 210, a central processing unit (CPU) 220, a hard disk drive (HDD) 230, a local area network (LAN) interface 240, an input and output interface 250, and a digital versatile disk (DVD) drive 260.

The RAM 210 is a memory that stores programs and progress results of executing the programs. The CPU 220 reads and executes a program from the RAM 210.

The HDD 230 is a disk device that stores programs and data. The LAN interface 240 is used for connecting the computer 200 to another computer through a LAN.

The input and output interface 250 is used for connecting an input device such as a mouse or a keyboard and a display device to the computer 200. The DVD drive 260 reads and writes data from and to a DVD.

A genetic relation extracting program 211 executed by the computer 200 is stored in the DVD, read from the DVD by the DVD drive 260, and installed in the computer 200.

Alternatively, the genetic relation extracting program 211 is stored in a database or the like of another computer system connected to the computer 200 through the LAN interface 240, read from the database, and installed in the computer 200.

The installed genetic relation extracting program 211 is stored in the HDD 230, read to the RAM 210, and executed as a genetic relation extracting process 221 by the CPU 220.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A computer-readable recording medium that stores a computer program for extracting a relation between a plurality of genes based on expression data regarding to an expression amount of the genes, wherein the computer program causes a computer to execute:
generating contexts based on expression data of a plurality of genes satisfying a predetermined relation, the contexts representing an environment for an expression of a gene; and
determining a relation between the genes in the contexts generated.

2. The computer-readable recording medium according to claim 1, wherein
the generating includes generating new contexts based on expression data of a plurality of genes of which the relation determined at the determining satisfies a predetermined relation,
the determining includes determining a relation between the genes in the new contexts generated.

3. The computer-readable recording medium according to claim 1, wherein the computer program further causes the computer to execute displaying a plurality of relations determined in a plurality of contexts generated.

4. The computer-readable recording medium according to claim 2, wherein
the determining includes determining the relation by calculating a correlation coefficient between expression amounts of two of the genes, and
the generating includes generating the new contexts based on expression data of a part of genes having the correlation coefficient higher than a predetermined threshold.

5. The computer-readable recording medium according to claim 2, wherein
the expression data includes a plurality of samples each of which including a plurality of expression amounts of the genes, and
the generating includes generating the new contexts based on a histogram of number of the samples versus average expression amount of the genes in each of the samples.

6. The computer-readable recording medium according to claim 2, wherein
the expression data includes a plurality of samples each of which including a plurality of expression amounts of the genes, and
the generating includes generating the new contexts by clustering the samples based on average expression amount of the genes in each of the samples.

7. The computer-readable recording medium according to claim 2, wherein
the expression data includes a plurality of samples each of which including a plurality of expression amounts of the genes, and
the generating includes generating the new contexts by binarizing each of the expression amounts based on average expression amount of the genes in each of the samples.

8. The computer-readable recording medium according to claim 2, wherein
the expression data includes a plurality of samples each of which including a plurality of expression amounts of the genes, and
the generating includes generating the new contexts based on a histogram of number of the samples versus first main component of the expression amounts of the genes in each of the samples, the first main component being obtained by singular value decomposition.

9. The computer-readable recording medium according to claim 1, wherein the generating includes:
generating the contexts and an evaluation value of the contexts based on the expression data;
displaying the contexts and the evaluation value generated so that a user can select specific contexts from among the contexts generated, and
generating the contexts based on the specific contexts selected.

10. The computer-readable recording medium according to claim 9, wherein the evaluation value calculated indicates a variation amount from original contexts.

11. The computer-readable recording medium according to claim 1, wherein the generating includes:
generating the contexts and an evaluation value of the contexts based on the expression data;
selecting specific contexts of which the evaluation value is higher than a predetermined threshold from among the contexts generated, and
generating the contexts based on the specific contexts selected.

12. The computer-readable recording medium according to claim 11, wherein the evaluation value calculated indicates a variation amount from original contexts.

13. A method for extracting a relation between a plurality of genes based on expression data regarding to an expression amount of the genes, the method comprising:
generating contexts based on expression data of a plurality of genes satisfying a predetermined relation, the contexts representing an environment for an expression of a gene; and
determining a relation between the genes in the contexts generated.

14. The method according to claim 13, wherein
the generating includes generating new contexts based on expression data of a plurality of genes of which the relation determined at the determining satisfies a predetermined relation,
the determining includes determining a relation between the genes in the new contexts generated.

15. The method according to claim 14, wherein
the determining includes determining the relation by calculating a correlation coefficient between expression amounts of two of the genes, and
the generating includes generating the new contexts based on expression data of a part of genes having the correlation coefficient higher than a predetermined threshold.

16. The method according to claim 14, wherein
the expression data includes a plurality of samples each of which including a plurality of expression amounts of the genes, and
the generating includes generating the new contexts based on a histogram of number of the samples versus average expression amount of the genes in each of the samples.

17. An apparatus for extracting a relation between a plurality of genes based on expression data regarding to an expression amount of the genes, the apparatus comprising:
a generating unit that generates contexts based on expression data of a plurality of genes satisfying a predetermined relation, the contexts representing an environment for an expression of a gene; and
a determining unit that determines a relation between the genes in the contexts generated.

18. The apparatus according to claim 17, wherein
the generating unit generates new contexts based on expression data of a plurality of genes of which the relation determined by the determining unit satisfies a predetermined relation,
the determining unit determines a relation between the genes in the new contexts generated.

19. The apparatus according to claim 18, wherein
the determining unit determines the relation by calculating a correlation coefficient between expression amounts of two of the genes, and
the generating unit generates the new contexts based on expression data of a part of genes having the correlation coefficient higher than a predetermined threshold.

20. The apparatus according to claim 18, wherein
the expression data includes a plurality of samples each of which including a plurality of expression amounts of the genes, and
the generating unit generates the new contexts based on a histogram of number of the samples versus average expression amount of the genes in each of the samples.
